(19) United States
(12) Patent Application Publication
(10) Pub. No.: US 2017/0177068 A1
(43) Pub. Date: Jun. 22, 2017

(54) SYSTEMS, METHODS AND DEVICES FOR STANDBY POWER SAVINGS

(71) Applicant: INTEL CORPORATION, Santa Clara, CA (US)

(72) Inventors: Barnes Cooper, Tigard, OR (US); Vidoot Ponnala Rathnakar, Hillsboro, OR (US)

(73) Assignee: INTEL CORPORATION, Santa Clara, CA (US)

(21) Appl. No.: 14/972,461

(22) Filed: Dec. 17, 2015

(51) Int. Cl. G06F 1/32; G06F 1/26

(52) U.S. Cl. CPC G06F 1/3296; G06F 1/263; G06F 1/3287

(57) ABSTRACT

A power delivery system of a computing system can switch the computing platform from a set of main rails to a standby rail in a low-power state. For example, using a power optimizer framework, a platform controller hardware (PCH) and/or platform management controller (PCU) can transition an idle computing system to a low-power state using a standby rail with the main rails off. The PCU can instruct a processor in a C10 state to switch from main power rails to a standby rail. Once confirmed that the processor is in the C10 state, the PCU can turn off a processor voltage regulator and assert a platform sleep signal. After confirming the platform has entered the sleep state in which the platform has moved to the standby rails, the PCH or PCU can request a power supply to turn off the main rails but leave the standby rail active.

### TECHNICAL FIELD

The present disclosure relates to power delivery to computing systems and more specifically relates to energy use efficiency of idle systems.

### BRIEF DESCRIPTION OF THE DRAWINGS

FIG. 1 is a schematic diagram illustrating a computing system consistent with embodiments disclosed herein.

FIG. 2 is a timing diagram illustrating signal timing consistent with embodiments disclosed herein.

FIG. 3 is a system diagram of a power delivery system consistent with embodiments disclosed herein.

FIG. 4 is a flow chart illustrating a method for standby power savings consistent with embodiments disclosed herein.

### DETAILED DESCRIPTION OF PREFERRED EMBODIMENTS

A detailed description of systems and methods consistent with embodiments of the present disclosure is provided below. While several embodiments are described, it should be understood that the disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

Techniques, apparatus and methods are disclosed that enable a power delivery system of a computing system to use a low-power state to switch the computing platform from a set of main rails to a standby rail. For example, using a power optimizer framework, a power management controller in the north side (PCU) or northbridge can transition an idle computing system to a low-power state using the standby rail with the main rails off. Processing cores (IA cores) and graphics cores (GT cores) become idle as the operating system (OS) and graphics driver complete associated workloads (e.g., threads). Upon the cores becoming idle, a power management controller in the north side (PCU) sends north side idle constraints (time to next event, minimum latency tolerance to the south side (or southbridge) platform controller hardware (PCH). The PCH responds with the idle constraints of the south side. Once the idle constraints are known for the platform (i.e., platform constraints), a low power state can be entered based on these parameters. In some embodiments, a platform management control unit (PMC) in the south side or southbridge is a responds to messages from the PCU.

In one embodiment, the PCU can instruct a processor to enter a C10 state in which the processor switches from the main power rails to a standby rail. Once confirmed that the processer is in the C10 state, the PCU can turn off a processor voltage regulator and assert a system transition signal (such as a platform sleep signal) to transition from a main power rail to a standby rail. After confirming the platform has entered the sleep state in which the platform has moved to the standby rail, the PCH can request the power supply turn off the main rails but leave the standby rail active.

Traditional advanced technology extended (ATX) desktop power supplies can lack efficiency at extremely low loads. However, changing the power supply design can have significant implications in the ecosystem (such as introducing incompatibility). By making minimal changes to the external ecosystem, power delivery can be managed in processor platforms with certain implications for silicon ingredients (central processing unit (CPU), platform control hardware (PCH)), power supply and power delivery architecture. A change in power delivery can affect components of a computing platform, including the CPU, PCH, power delivery architecture, board design and power supply units (PSUs). In some embodiments, an approach can be used that allows systems to safely enter and/or exit high-latency PSU states (e.g., 100 ms recovery times) by making use of the power optimizer infrastructure in a platform.

Multi-rail ATX power supplies can be inefficient at low loads. Power supplies can be 20-30% efficient at 1-3% DC system loads in connected standby-like low-power system conditions. However, the standby rail (5 volt) has already been optimized for low load conditions, and this rail can be greater than 70% efficient at less than 300 mA load. However, the standby rail is currently used in advanced configuration and power interface (ACPI) S3 and S5 states (the main rails are turned off using the SLP_S3# signal).

A new architecture of power distribution can be used to extend the use of this rail in low-power S0 idle platform conditions. To understand the new capabilities that the standby rail can be architected for, one needs to consider a couple of conditions. In idle, most of the components on the platform continue to operate in a low-power state. Changes can be made in the power delivery architecture to allow these components which are not tied to the standby (STBY) rail before are connected now. Also, even when in idle, operating system (OS) and communications activity can occur.

Silicon and component average-idle-power targets can be set to take advantage of the high efficiency of the standby rail, maintain quality of service and present a good experience to the user. In some cases, it can be beneficial to continue to remain on the standby rail, even during a low-activity period. With these demands, more load capacity on the standby rail can be needed, since various platform components like the CPU, PCH, communications devices, etc., can be expected to be active (but in a low-activity state).

Typical power supplies today in mainstream desktop systems are rated to a maximum load capacity of 2.5 A on the 5 volt standby rail, which results in an available power budget of 12.5 watts. According to internal platform power budgeting analysis, this is not enough to power all components in an active state. In some embodiments, therefore, it can be desirable to increase the capacity of the standby rail of the power supply (some of which can be designed to support 5A-6A on the standby rail).

In some embodiments, a scenario can cross a power demand threshold, like OS activity (e.g., OS-initiated hard disk drive (HDD) access) or user activity (e.g., audio playback) when a load becomes too high on the standby rail. To support these types of scenarios, where a load on the standby rail crosses a predefined (and/or designed) threshold level, the components can be switched back to the main rails of the PSU. In some embodiments, this switching between the standby rail and main rails (also depending on the system state) can be designed with controls to be able to meet power, timing and user experience constraints. A back-and-forth switching can create challenges to the power delivery architecture.

Runtime D3 (RTD3) (a device power state) can be used to help desktop and/or all-in-one (DT/AIO) platforms to achieve platform power targets. Interfaces which are of interest to DT/AIO include peripheral component interconnect express (PCIe), universal serial bus (USB), processor graphics PCIe port (PEG), audio, and serial advanced technology attachment (SATA). For example, a DT/AIO system can include the following interfaces and devices. A PCIe interface can include connections to graphics on PEG port, TV tuner, WLAN, LAN and/or card readers. A USB interface can include connections to HID devices, touch screens, cameras and/or card readers. A SATA interface can include connections to HDDs and DVD/BD drives. A wireless interface can include connections to HID devices over Bluetooth™ (BT) and audio devices. Switchable graphics can be used in conjunction with a discrete card in the DT/AIO platforms to aid in hitting power targets with a monitor on.

In one embodiment, LAN and WLAN (WiFi+BT combo card) NIC which can be on PCIe are left on. The platform power budget can be created to absorb a power consumption of these devices when in idle. Device drivers can be configured to ensure that LAN and WLAN are not placed in RTD3. However, if PCH can support wake capability of PCIe devices, LAN/WLAN can also be put into RTD3 (this feature was not supported in LPT-H). Additional latency tolerance reporting (LTR) requirements and wake filter settings can be used.

Depending on the embodiments, fine-grained power control of each device can be used, or devices of a particular interface can be tied to a single power control. For example, an option can be that all devices on an interface exit RTD3 when a single device is needed.

S3 power state implementations can be replaced with S0ix power state implementations. The described embodiments herein can allow computing systems to switch to the PSU standby rail (which can be used for Sx power states) in desktop long-idle (S0ix-based power states), light-load conditions. By entering a C10 state, the system on a chip (SoC) (e.g., CPU) can be transitioned to a very low-power state. In an embodiment, upon entering the C10 state, the 12 volt rail that feeds the fully integrated voltage regulator (FIVR) source rail is powered off, which reduces demand. By using an SLP_S0# signal, the PCH can switch remaining required rails (for example, 3.3 volt, PCH Core rails, etc.) to the 5 volt standby rail of the PSU.

In one embodiment, after a settling period, the SoC can sequence to a new C11 state, which de-asserts the power supply enablement, which results in the PSU powering off the traditional power rails feeding the platform that have inherently low efficiency at a light load. Components that remain on are switched to the efficient light-load 5 volt standby rail. Upon waking up, the power supply is started (which can be facilitated by a power optimizer system that determines when the system will wake) to warm up the PSU, before the CPU exits the C10 state and sequences SoC back on.

In some embodiments, regulatory changes are potentially moving from a 25 watt idle power (A/C power from the wall) to a 10 watt target idle power. By adapting the power delivery systems as described within, the 10 watt target can be achievable.

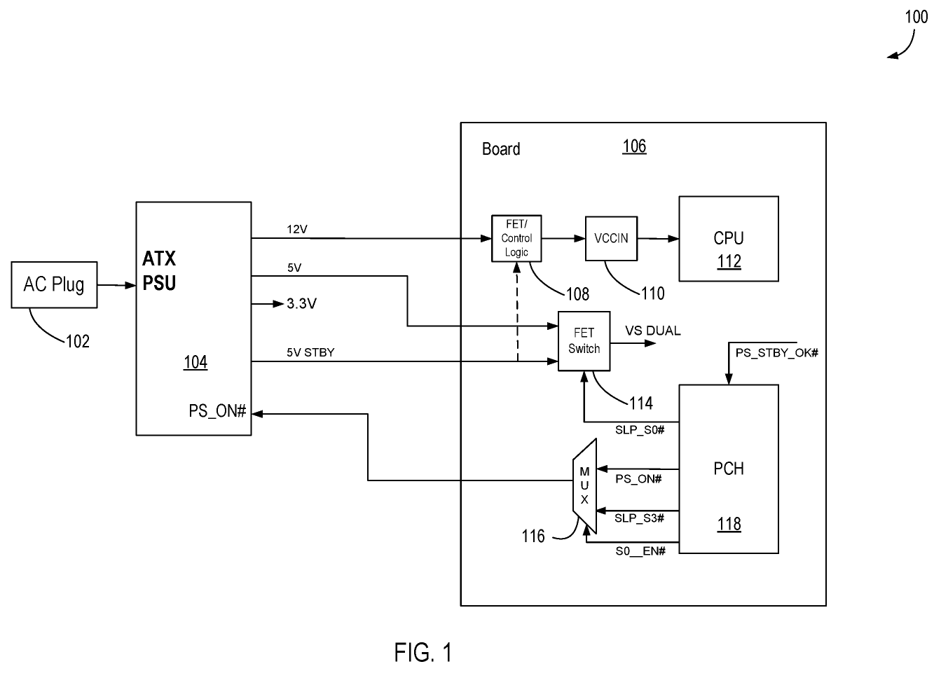

FIG. 1 is a schematic diagram illustrating a computing system 100 consistent with embodiments disclosed herein. An alternating current (A/C) plug 102 receives power and provides it to a power supply, which in this embodiment is an advanced technology extended (ATX) power supply unit (PSU) 104. The ATX PSU 104 provides power to a circuit board 106 and can receive signals from and/or send signals to the circuit board 106. In the embodiment shown, the ATX PSU 104 provides a 12 volt rail, a 5 volt rail, a 3.3 volt rail and a 5 volt standby rail. The ATX PSU 104 also receives a PS_ON# signal that can switch on or off the 12 volt rail, 5 volt rail and 3.3 volt rail (also collectively known as the main rails). The 5 volt standby rail, however, can remain on in either state.

In the power delivery architecture shown, a power supply rail (VCCIN) 110 to the CPU 112 can switch between the 12 volt rail and 5 volt standby rail. A field-effect transistor (FET)/Control logic 108 can be used to accomplish this switching. A signal PS_ON# can indicate to the ATX PSU 104 when to turn off the main rails of the ATX PSU 104. This signal is asserted when predefined platform idle conditions are met. It should be noted that the PS_ON# signal indicated here can be different from a signal generated by motherboard logic today to turn on or off the power supply. A naming convention can change in the future.

Components on the board can be supplied by a FET Switch 114. This allows components to receive the 5 volt rail when the ATX PSU 104 is active and the 5 volt standby rail when the ATX PSU 104 is in a standby state.

A PCH 118 can control the state of the FET Switch 114, CPU 112 and the ATX PSU 104. In the embodiment shown, the PCH 118 can assert a SLP_S0# signal to switch components from a main rail, such as the 5 volt rail, to the 5 volt standby rail. The PCH 118 can also transmit signals to control the ATX PSU 104. In the embodiment shown, the PCH 118 uses a multiplexer (MUX) 116 to multiplex the PS_ON# signal with the SLP_S3# signal. When the PCH 118 enters an S0 state, the S0 signal is sent to the MUX 116. This S0_EN# signal enables the MUX 116 to transmit the state of the PS_ON# signal (instead of the SLP_S3# signal) to the ATX PSU 104. When not in the S0 idle state, the MUX 116 is configured to transmit the state of the SLP_S3# signal to the ATX PSU 104.

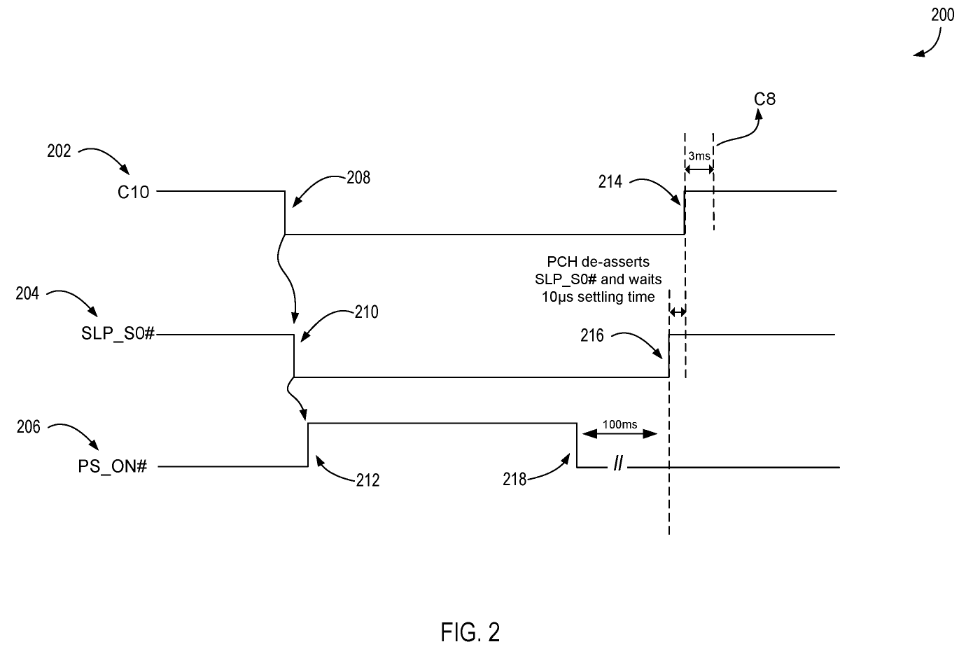

FIG. 2 is a timing diagram illustrating a signal timing 200 consistent with embodiments disclosed herein. The timing 200 can be representative of systems, such as those shown in FIG. 1, including the CPU and ATX PSU including the SLP_S0# and PS_ON# signals. After the CPU progressively enters 208 a C10 state 202 and the fully integrated voltage regulator (FIVR) first stage voltage regulator is shut off, an SLP_S0# signal 204 can be asserted 210 by the PCH. A PS_ON# signal 206 can then be de-asserted 212 after a settling time, which signals to the PSU to turn off its main rails.

When a break and/or exit from the low-power S0 idle condition is detected by the PCH, or a time until next time (TNTE) warm-up time is being approached, the PCH can assert 218 the PS_ON# signal 206 and wait a PSU settling time (e.g., 100 ms using a timer) for the main rails to ramp up while the CPU remains in a C10 low-power state. The PCH de-asserts 216 the SLP_S0# signal 204 and waits a component settling time (for example, 10 μs or less, depending on the components) for the motherboard voltage regulators to switch and stabilize before triggering the CPU to exit the C10 state 202. After this component settling time has passed, the PCH can indicate to the CPU through a PMSync message 214 to exit the C10 state 202, which has a recovery time (e.g., 3 ms) for external voltage regulators. The CPU can then be in an active state (such as C0).

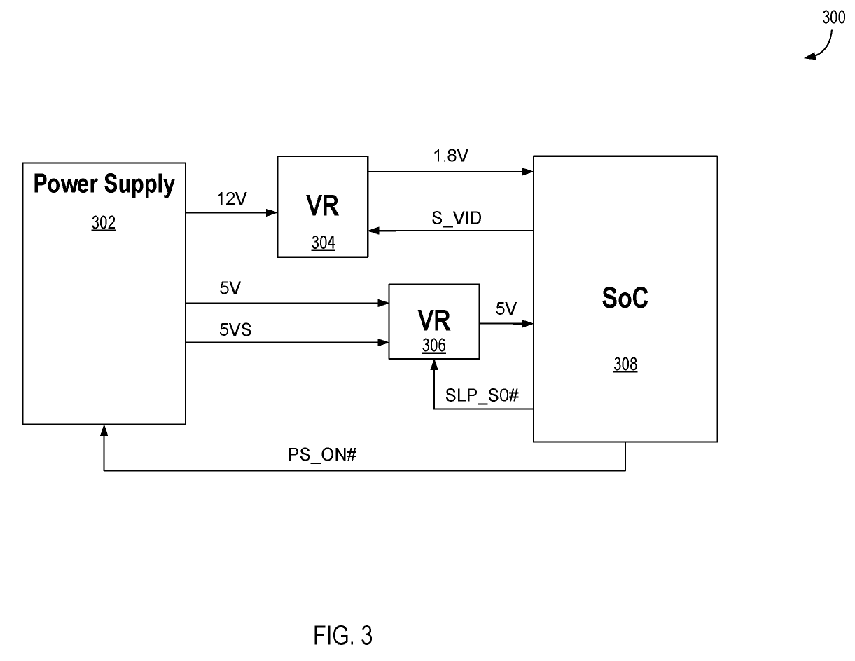

FIG. 3 is a system diagram of a power delivery system 300. The power delivery system 300 can include a power supply 302, a 12 volt voltage regulator 304, a 5 volt voltage regulator 306 and a system on a chip 308. The power delivery system 300 can implement systems that move a computing system from main rail power to standby power, such as entering a PC10 state using a PC10 flow process.

A PC10 flow process can be used to perform motherboard supply actions. The PC10 flow can include operations that control a voltage regulator that feeds the FIVR. The FIVR can operate at 1.8 volts in a nominal state, at 1.2 volts in a PC8 state, and at 0 volts in a PC9 state, and can be off in a PC10 state. In some embodiments, recovery times for exiting PC10 can range from 400 μs to 3 ms. An ATX power supply can be sequenced with a warm-up delay such that a 12 volt rail is stable before reactivating the FIVR source rail.

In some embodiments, components can be registered with the system, including a maximum platform latency tolerance (which can include both a north bridge and a south bridge). For example, a PSU can have a 100 ms warm-up time, and the voltage regulators for the CPU can have a 3 ms warm-up time, for a total of 103 ms. These warm-up times can be stored in registers within the PCH. For example, a platform power supply recovery time register can be set for 100 ms. A platform SP_S0# recovery time can be set for 10 μs.

Signals can be created for use with a PC10 state. For example, a PS_ON# signal can be de-asserted to switch off main rails of the power supply. A PS_STBY_OK# signal can be used to indicate that system peripherals allow for operation from a standby rail. A PMSync virtual signal can be used to indicate that a C10 state has been entered by a south bridge, and that the north bridge requires less warm-up time than the south bridge.

Exiting a power-saving state can be done synchronously or asynchronously. For example, in a synchronous exit, a warm-up timer is visible to both a north bridge and a south bridge. As the south bridge (in this example) requires more warm-up time, the south bridge controls assertion of a PS_ON# signal. In another example, in an asynchronous exit, the north bridge indicates an exit event to the south bridge (such as through a PMDown message). The north bridge then waits for a maximum platform recovery time based on the exited power state (as described in a PMSync message from the south bridge). The north bridge then warms up in time to be ready for the CPU to exit a C10 state after the C10 warm-up is completed (e.g., 100 ms).

In some embodiments, a PCH checks PCIe LTR values and/or allows PCIe root ports (RPs) to be in D3.

For example, a PC10 entry flow process can include the following operations. A PCU detects that the system is idling (e.g., a user-away condition). The PCU detects that the CPU is not in use. The PCU gives the CPU an instruction to enter a C10 power state. The PCU then receives a confirmation that the CPU is in a C10 power state. The PCU then turns off the FIVR. The PCU checks to make sure the platform is in an idle state. The PCH then asserts an SLP_S0# signal when the platform is confirmed to be in an idle state. The PCH then de-asserts the PS_ON# signal.

In one example, a last CPU issues an MWAIT(C10) command (Gfx in RC6, display off, PEG RTD3 or LTR=NoReq). A PMReq/Rsp indicates a C10 entry confirmed by the processor. A north bridge can take 3 ms and a south bridge can take 103 ms to enter C10. By definition, in this example, peripherals are in RTD3 as required; otherwise a tighter LTR would be detected (e.g., SATA in slumber or off state). The north bridge enters C10 and shuts off the FIVR first stage voltage regulator. The PCH asserts SLP_S0# to switch remaining system rails to the 5 volt standby rail. Note that the system can be optimized to run as many light-load rails as possible from the 5 volt standby rail. After a settling time, the PCH de-asserts the PS_ON# signal.

For example, a PC10 exit flow process can include the following operations. A PCH is informed of a wake-up event. The PCH asserts the PS_ON# signal. The PCH waits for a power supply settling time (such as a 100 ms timer). The CPU remains in C10 during the warm-up time. The SLP_S0# signal is de-asserted, which causes the platform to switch from the 5 volt standby rail to the main rails. A platform settling time passes, to make sure the platform is out of the idle state. The PCH wakes the CPU, north bridge and south bridge using the PMSync protocol. The CPU waits a CPU settling time for external voltage regulators to enter an active state. The north bridge and the PCH exit from the low-power state to a C2 or C0 state. It should be noted that a multi-rail power supply or a single-rail power supply can be used.

In one example of a PC10 exit flow process, a break condition is detected by the south bridge (asynch) or a TNTE warm-up time (103 ms) occurs. The PCH asserts a PS_ON# signal and begins a 100 ms warm-up timer. During the warm-up, the north bridge remains in C10. The PCH de-asserts the SLP_S0# signal and waits a platform settling time. The PCH uses a PMSync protocol to wake the north bridge. The north bridge begins exiting the C10 state with a 3 ms recovery time for external voltage regulators. The north bridge and PCH exit to a C2 or C0 state.

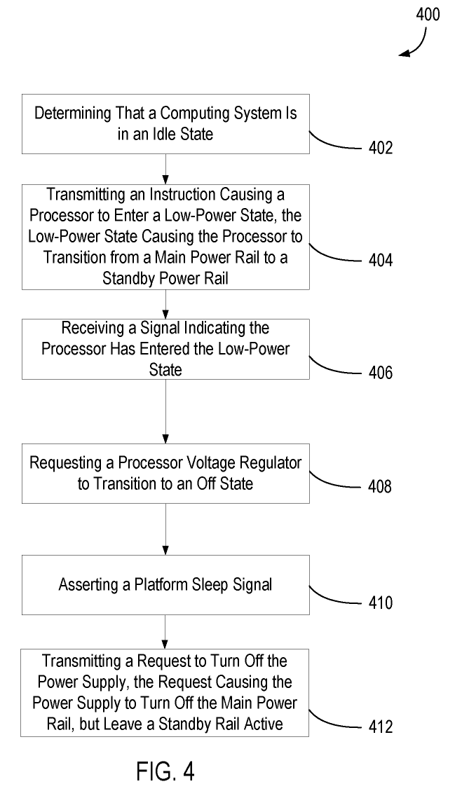

FIG. 4 is a flow chart illustrating a method 400 for standby power savings consistent with embodiments disclosed herein. The method 400 can be implemented by systems such as those shown in FIG. 1 and/or FIG. 3, including the ATX PSU 104, a CPU 112 and the PCH 118. In block 402, the PCH determines that a computing system is in an idle state. In block 404, the PCU transmits an instruction causing a processor to enter a low-power state, the low-power state causing the processor to transition from a main power rail to a standby power rail. In block 406, the PCU receives a signal indicating the processor has entered the low-power state. In block 408, the PCU requests a processor voltage regulator to transition to an off state. In block 410, the PCH asserts a platform sleep signal. In block 412, the PCH transmits a request to turn off the power supply, the request causing the power supply to turn off the main power rail but leave a standby rail active.

### Examples

Example 1 is a system for transitioning to a low-power state. The system includes a power supply, a processor, a south power management unit (PMC), and a north power management control unit (PCU). The power supply is electrically coupled to the system and includes a main power output and a standby power output. The processor receives power from the main power output and the standby power output. The south power management unit (PMC) is coupled to the power supply and south side platform components. The north power management control unit (PCU) is coupled to the power supply and the processor. The PCU is configured to determine that the system is in an idle state, transmit north side idle constraints to the PMC, receive south side idle constraints from the PMC, and transition the processor to the low-power state. The low-power state causes the processor to transition from a main power rail to a standby power rail. The PMC is also configured to transmit a system transition signal to cause system components to switch from the main power output to the standby power output, determine that the north side idle constraints and south side idle constraints have been met, and transmit a request to turn off the power supply; the request causing the power supply to turn off the main power rail and leave the standby power rail active.

Example 2 includes the system of Example 1, where the power supply is an advanced technology extended (ATX) multi-rail power supply.

Example 3 includes the system of Example 1, where the power supply is an ATX single-rail power supply.

Example 4 includes the system of any of Examples 1-3, where the power supply is a multi-rail power supply.

Example 5 includes the system of any of Examples 1-4, where the main power output is a 12 volt output.

Example 6 includes the system of any of Examples 1-5, where the standby power output is a 5 volt output.

Example 7 includes the system of any of Examples 1-6, where the low-power state of the processor is a C10 package state.

Example 8 includes the system of any of Example 1-6, where the system transition signal is a SLEEP S ZERO (SLP_S0#) signal.

Example 9 includes the system of any of Examples 1-6, where the PCU is configured to receive a signal indicating the processor has entered the low-power state which causes the processor to transition from the main power rail to the standby power rail.

Example 10 includes the system of any of Examples 1-6, where the processor is configured to request a processor voltage regulator transition to an off state when the processor transitions to the low-power state.

Example 11 includes the system of Example 10, where the processor voltage regulator is a fully integrated voltage regulator (FIVR).

Example 12 includes a power control unit (PCU) device for reducing power consumption. The device includes a power supply interface, a central processing unit (CPU) interface, and a system interface. The power supply interface sends a sleep signal and an on/off signal to a power supply, the central processing unit (CPU) interface communicates a power state of a CPU, and the system interface communicates to computing system components a low-power state switch from a main power rail to a standby power rail. The processor then determines that hardware threads of the CPU are idle, receives platform idle constraints, and causes the processor to enter a low-power state, wherein the processor transitions from the main power rail to the standby power rail and transmits a system transition signal causing the computing system components to switch from the main power rail to the standby power rail. Thus, when the platform idle constraints are met, they transmit a request to turn off the power supply, causing the power supply to turn off the main power rail and leave the standby rail active.

Example 13 includes the device of Example 12, where the processor waits a settling time between transmitting the instruction causing the processor to enter the low-power state and transmitting the system transition signal.

Example 14 includes the device of any of Examples 12-13, where the power state is a package C-State.

Example 15 includes the device of Example 12, where the power state is a C10 state.

Example 16 includes the device of any of Examples 12-15, where the processor receives a signal indicating the processor has entered the low-power state.

Example 17 includes the device of any of Examples 12-15, where the processor determines a settling time for the computing system components when transitioning from the main rail to the standby rail, based on a power framework that describes a maximum settling time of the computing system components.

Example 18 includes the device of any of Examples 12-17, where the power framework is a power optimizer framework.

Example 19 is a method of transitioning to a low-power state in a computing platform. The method includes determining that a computing system is in an idle state, receiving platform idle constraints, and causing a processor to enter the low-power state. The low-power state causes the processor to transition from a main power rail to a standby power rail. The method also includes receiving a signal indicating the processor has entered the low-power state, requesting a processor voltage regulator to transition to an off state, asserting a platform sleep signal, determining the platform idle constraints have been met; and transmitting a request to turn off a power supply. The request causes the power supply to turn off the main power rail but leave the standby rail active.

Example 20 is a method of Example 19 which includes waiting a settling time between asserting the platform sleep signal and transmitting the request to turn off the power supply.

Example 21 is a method of Example 20, where the settling time is 100 milliseconds.

Example 22 is a method of Example 19, which determines that components of the computing platform are in an idle state after asserting the platform sleep signal.

Example 23 is a method of Example 22, where asserting the platform sleep signal includes asserting a SLEEP S ZERO (SLP_S0#) signal.

Example 24 is a method of any of Examples 19-23, where turning off the power supply includes de-asserting a power supply on (PS_ON#) signal.

Example 25 is a method of transitioning from a low-power state in a computing platform. The method includes determining that a wake-up event has occurred, transmitting a request to turn on a power supply, transmitting a system transition signal to cause system components to switch from a standby power rail to the a main power rail, and transmitting an instruction which causes a central processing unit (CPU) to transition from the low-power state to an active state. This transition also causes the CPU to transition from the standby power rail to the main power rail.

Example 26 is a method of Example 25, where transmitting a system transition signal includes de-asserting a SLEEP S ZERO (SLP_S0#) signal.

Example 27 is a method of any of Examples 25-26, where transmitting a request to turn on a power supply includes asserting a power supply on (PS_ON#) signal.

Example 28 is an apparatus which includes a method in any of Examples 19-27.

Example 29 is a machine-readable storage. The machine-readable storage includes instructions to implement a method or realize an apparatus as shown in any of Examples 19-27.

Example 30 is a machine-readable medium. The machine-readable medium includes code which causes a machine to perform the method of any one of Examples 19-27.

Example 31 is a power management control unit (PCU) device for reducing power consumption. The device includes a power supply interface, a central processing unit (CPU) interface, a system interface, and a processor. The power supply interface sends a sleep signal and an on/off signal to a power supply. The central processing unit (CPU) interface communicates a power state of a CPU, and the system interface communicates to system components a low-power state switch from a main power rail to a standby power rail. The processor determines that a wake-up event has occurred and transmits a request to turn on the power supply. This causes the power supply to turn on the main power rail and transmit a system transition signal which in turn causes the system components to switch from the standby power rail to the main power rail. When wake-up constraints have been met, the power supply further transmits instructions to the CPU to transition from a low-power state to an active state. The transition causes the processor to transition from the standby power rail to the main power rail.

Example 32 is a device of Example 31, where the PCU is configured to use a power management sync (PMSync) protocol.

Example 33 is a device of any of Examples 31-32, where the system transition signal is a de-asserted SLEEP S ZERO (SLP_S0#) signal.

Example 34 is a device of any of Example 31-33, where the PCU is configured to wait for a time period between requesting the system components to switch from the standby power output to the main power output and transmitting the instruction causing the CPU to transition from the low-power state to the active state.

Example 35 is a device of any of Examples 31-34, where after receiving the instruction causing the CPU to transition from the low-power state to the active state, the CPU waits for a time period to allow a processor voltage regulator to transition to an active regulating state.

Example 36 is a device of any of Examples 31-35, where the system is configured to wait for a time period between requesting the power supply to turn on and transmitting the system transition signal.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

Computer systems and the computers in a computer system may be connected via a network. Suitable networks for configuration and/or use as described herein include one or more local area networks, wide area networks, metropolitan area networks, and/or Internet or IP networks, such as the World Wide Web, a private Internet, a secure Internet, a value-added network, a virtual private network, an extranet, an intranet, or even stand-alone machines which communicate with other machines by physical transport of media. In particular, a suitable network may be formed from parts or entireties of two or more other networks, including networks using disparate hardware and network communication technologies.

One suitable network includes a server and one or more clients; other suitable networks may contain other combinations of servers, clients, and/or peer-to-peer nodes, and a given computer system may function both as a client and as a server. Each network includes at least two computers or computer systems, such as the server and/or clients. A computer system may include a workstation, laptop computer, disconnectable mobile computer, server, mainframe, cluster, so-called “network computer” or “thin client,” tablet, smart phone, personal digital assistant or other hand-held computing device, “smart” consumer electronics device or appliance, medical device, or a combination thereof.

Suitable networks may include communications or networking software, such as the software available from Novell®, Microsoft®, and other vendors, and may operate using TCP/IP, SPX, IPX, and other protocols over twisted pair, coaxial, or optical fiber cables, telephone lines, radio waves, satellites, microwave relays, modulated AC power lines, physical media transfer, and/or other data transmission “wires” known to those of skill in the art. The network may encompass smaller networks and/or be connectable to other networks through a gateway or similar mechanism.

Various techniques, or certain aspects or portions thereof, may take the form of program code (i.e., instructions) embodied in tangible media, such as floppy diskettes, CD-ROMs, hard drives, magnetic or optical cards, solid-state memory devices, a nontransitory computer-readable storage medium, or any other machine-readable storage medium wherein, when the program code is loaded into and executed by a machine, such as a computer, the machine becomes an apparatus for practicing the various techniques. In the case of program code execution on programmable computers, the computing device may include a processor, a storage medium readable by the processor (including volatile and nonvolatile memory and/or storage elements), at least one input device, and at least one output device. The volatile and nonvolatile memory and/or storage elements may be a RAM, an EPROM, a flash drive, an optical drive, a magnetic hard drive, or other medium for storing electronic data. One or more programs that may implement or utilize the various techniques described herein may use an application programming interface (API), reusable controls, and the like. Such programs may be implemented in a high-level procedural or an object-oriented programming language to communicate with a computer system. However, the program(s) may be implemented in assembly or machine language, if desired. In any case, the language may be a compiled or interpreted language, and combined with hardware implementations.

Each computer system includes one or more processors and/or memory; computer systems may also include various input devices and/or output devices. The processor may include a general-purpose device, such as an Intel®, AMD®, or other “off-the-shelf” microprocessor. The processor may include a special-purpose processing device, such as ASIC, SoC, SiP, FPGA, PAL, PLA, FPLA, PLD, or other customized or programmable device. The memory may include static RAM, dynamic RAM, flash memory, one or more flip-flops, ROM, CD-ROM, DVD, disk, tape, or magnetic, optical, or other computer storage medium. The input device(s) may include a keyboard, mouse, touch screen, light pen, tablet, microphone, sensor, or other hardware with accompanying firmware and/or software. The output device(s) may include a monitor or other display, printer, speech or text synthesizer, switch, signal line, or other hardware with accompanying firmware and/or software.

It should be understood that many of the functional units described in this specification may be implemented as one or more components, which is a term used to more particularly emphasize their implementation independence. For example, a component may be implemented as a hardware circuit comprising custom very large scale integration (VLSI) circuits or gate arrays, or off-the-shelf semiconductors such as logic chips, transistors, or other discrete components. A component may also be implemented in programmable hardware devices such as field programmable gate arrays, programmable array logic, programmable logic devices, or the like.

Components may also be implemented in software for execution by various types of processors. An identified component of executable code may, for instance, comprise one or more physical or logical blocks of computer instructions, which may, for instance, be organized as an object, a procedure, or a function. Nevertheless, the executables of an identified component need not be physically located together, but may comprise disparate instructions stored in different locations that, when joined logically together, comprise the component and achieve the stated purpose for the component.

Indeed, a component of executable code may be a single instruction, or many instructions, and may even be distributed over several different code segments, among different programs, and across several memory devices. Similarly, operational data may be identified and illustrated herein within components, and may be embodied in any suitable form and organized within any suitable type of data structure. The operational data may be collected as a single data set, or may be distributed over different locations including over different storage devices, and may exist, at least partially, merely as electronic signals on a system or network. The components may be passive or active, including agents operable to perform desired functions.

Several aspects of the embodiments described will be illustrated as software modules or components. As used herein, a software module or component may include any type of computer instruction or computer-executable code located within a memory device. A software module may, for instance, include one or more physical or logical blocks of computer instructions, which may be organized as a routine, program, object, component, data structure, etc., that perform one or more tasks or implement particular data types. It is appreciated that a software module may be implemented in hardware and/or firmware instead of or in addition to software. One or more of the functional modules described herein may be separated into sub-modules and/or combined into a single or smaller number of modules.

In certain embodiments, a particular software module may include disparate instructions stored in different locations of a memory device, different memory devices, or different computers, which together implement the described functionality of the module. Indeed, a module may include a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

Reference throughout this specification to “an example” means that a particular feature, structure, or characteristic described in connection with the example is included in at least one embodiment of the present invention. Thus, appearances of the phrase “in an example” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on its presentation in a common group without indications to the contrary. In addition, various embodiments and examples of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of materials, frequencies, sizes, lengths, widths, shapes, etc., to provide a thorough understanding of embodiments of the invention. One skilled in the relevant art will recognize, however, that the invention may be practiced without one or more of the specific details, or with other methods, components, materials, etc. In other instances, well-known structures, materials, or operations are not shown or described in detail to avoid obscuring aspects of the invention.

It should be recognized that the systems described herein include descriptions of specific embodiments. These embodiments can be combined into single systems, partially combined into other systems, split into multiple systems or divided or combined in other ways. In addition, it is contemplated that parameters/attributes/aspects/etc. of one embodiment can be used in another embodiment. The parameters/attributes/aspects/etc. are merely described in one or more embodiments for clarity, and it is recognized that the parameters/attributes/aspects/etc. can be combined with or substituted for parameters/attributes/etc. of another embodiment unless specifically disclaimed herein.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the invention is not to be limited to the details given herein, but may be modified within the scope and equivalents of the appended claims.

Those having skill in the art will appreciate that many changes may be made to the details of the above-described embodiments without departing from the underlying principles of the invention. The scope of the present invention should, therefore, be determined only by the following claims.

1. A system for transitioning to a low-power state, comprising:
a power supply electrically coupled to the system, the power supply comprising:
a main power output; and
a standby power output;
a processor receiving power from the main power output and the standby power output;
a south power management unit (PMC) coupled to the power supply and south side platform components; and
a north power management control unit (PCU) coupled to the power supply and the processor, the PCU configured to:
determine that the system is in an idle state;
transmit north side idle constraints to the PMC;
receive south side idle constraints from the PMC;
transition the processor to the low-power state, the low-power state causing the processor to transition from a main power rail to a standby power rail;
transmit a system transition signal to cause system components to switch from the main power output to the standby power output;
determine that the north side idle constraints and south side idle constraints have been met; and
transmit a request to turn off the power supply, the request causing the power supply to turn off the main power rail and leave the standby power rail active.

2. The system of claim 1, wherein the power supply is an advanced technology extended (ATX) multi-rail power supply.

3. The system of claim 1, wherein the power supply is an advanced technology extended (ATX) single-rail power supply.

4. The system of any of claim 1, wherein the low-power state of the processor is a C10 package state.

5. The system of any of claim 1, wherein the system transition signal is a SLEEP S ZERO (SLP_S0#) signal.

6. The system of any of claim 1, wherein the PCU is further configured to receive a signal indicating the processor has entered the low-power state, the low-power state causing the processor to transition from the main power rail to the standby power rail.

7. The system of any of claim 1, wherein the processor is configured to request a processor voltage regulator transition to an off state, when the processor transitions to the low-power state.

8. The system of claim 7, wherein processor voltage regulator is a fully integrated voltage regulator (FIVR).

9. A power control unit (PCU) device for reducing power consumption, comprising:
a power supply interface configured to send a sleep signal and an on/off signal to a power supply;
a central processing unit (CPU) interface configured to communicate a power state of a CPU;
a system interface configured to communicate to computing system components a low-power state switch from a main power rail to a standby power rail; and
a processor configured to:
determine that hardware threads of the CPU are idle;
receive platform idle constraints;
cause the processor to enter a low-power state, the low-power state causing the processor to transition from the main power rail to the standby power rail;
transmit a system transition signal to cause the computing system components to switch from the main power rail to the standby power rail; and
when the platform idle constraints are met, transmit a request to turn off the power supply, the request causing the power supply to turn off the main power rail and leave the standby rail active.

10. The device of claim 9, wherein the processor is further configured to wait a settling time between transmitting the instruction causing the processor to enter the low-power state and transmitting the system transition signal.

11. The device of claim 9, wherein the power state is a package C-State.

12. The device of claim 9, wherein the power state is a C10 state.

13. The device of any of claim 9, wherein the processor is further configured to determine a settling time for the computing system components when transitioning from the main rail to the standby rail based at least in part on a power framework that describes a maximum settling time of the computing system components.

14. A method of transitioning to a low-power state in a computing platform, comprising:
determining that a computing system is in an idle state;
receiving platform idle constraints;
causing a processor to enter the low-power state, the low-power state causing the processor to transition from a main power rail to a standby power rail;
receiving a signal indicating the processor has entered the low-power state;
requesting a processor voltage regulator to transition to an off state;
asserting a platform sleep signal;
determining the platform idle constraints have been met; and
transmitting a request to turn off a power supply, the request causing the power supply to turn off the main power rail but leave the standby rail active.

15. The method of claim 14, further comprising waiting a settling time between asserting the platform sleep signal and transmitting the request to turn off the power supply.

16. The method of claim 15, wherein the settling time is 100 milliseconds.

17. The method of claim 14, further comprising determining that components of the computing platform are in an idle state after asserting the platform sleep signal.

18. The method of claim 17, wherein asserting the platform sleep signal further comprises asserting a SLEEP S ZERO (SLP_S0#) signal.

19. The method of claim 14, wherein turning off the power supply further comprises de-asserting a power supply on (PS_ON#) signal.

20. A method of transitioning from a low-power state in a computing platform, comprising:
determining that a wake-up event has occurred;
transmitting a request to turn on a power supply, the request causing the power supply to turn on a main power rail;
transmitting a system transition signal to cause system components to switch from a standby power rail to the a main power rail; and
transmitting an instruction causing a central processing unit (CPU) to transition from the low-power state to an active state, the transition causing the CPU to transition from the standby power rail to the main power rail.

21. The method of claim 20, wherein transmitting a system transition signal further comprises deasserting a SLEEP S ZERO (SLP_S0#) signal.

22. The method of claim 20, wherein transmitting a request to turn on a power supply further comprises asserting a power supply on (PS_ON#) signal.
